(19) United States
(12) Patent Application Publication
(10) Pub. No.: US 2011/0239503 A1
(43) Pub. Date: Oct. 6, 2011

(54) PATTERN/CHARACTER DISPLAYING LED LAMP STRUCTURE WITH INVISIBLE T-BAR SUPPORT

(76) Inventor: Hsu-Wen LIAO, Pingjhen City (TW)

(21) Appl. No.: 12/749,968

(22) Filed: Mar. 30, 2010

(51) Int. Cl. G09F 9/302; F21S 4/00; G09F 13/00

(52) U.S. Cl. 40/550; 362/249.02

(57) ABSTRACT

A pattern/character displaying LED lamp structure with invisible T-bar support is disclosed. The LED lamp structure includes a plurality of T-bars assembled to define a plurality of framed spaced; a plurality of stepped lamp panels; and a plurality of LED lamps. The stepped lamp panels respectively have a size-reduced upper half and a size-expanded lower half. When the upper halves are upward set in the framed spaces, the lower halves are in contact with one another to cover the T-bars, making the T-bars invisibly located behind the lamp panels. A bottom wall of each of the lamp panels is provided with lamp holes for forming characters or patterns. The LED lamps are separately set in the lamp holes with light-emitting sections thereof downward projected beyond the lamp panels, and can be lightened to display the characters or patterns on the bottom walls of the lamp panels.

### FIELD OF THE INVENTION

The present invention relates to a pattern/character displaying LED lamp structure with invisible T-bar support, and more particularly to an LED lamp structure that enables displaying of complete large-sized patterns and characters on a ceiling, to which the LED lamp structure is mounted.

### BACKGROUND OF THE INVENTION

For the purpose of environmental protection and power energy saving, as well as providing changeful lighting patterns, light-emitting-diode (LED) lamps have become one of the best choices for using as light sources. Generally, the currently available LED ceiling lights are recessed lamps set in the ceiling or light panels supported on T-bars to locate below the ceiling. All these conventional LED ceiling lights are only used as lighting fixture without the function of providing changeful patterns or characters thereon.

Currently, there are many billboards and signboards using LED lamps, so that different patterns and/or characters can be changefully displayed on the billboards or the signboards. However, LED lamps allowing the display of changeful patterns and characters are not suitable for use with LED ceiling lights because the LED ceiling lights are supported on T-bars and separated by the T-bars to form many discrete areas, patterns or characters displayed on the LED ceiling lights would be cut apart by the exposed T-bars into discontinuous sections, as can be seen in FIG. 1. The displayed patterns or characters with discontinuous sections are not beautiful.

It is therefore tried by the inventor to develop a pattern/character displaying LED lamp structure with invisible T-bar support, which can be used not only as lighting fixture, but also as a special lighting device to display large-sized patterns or characters showing, for example, a company logo, so as to effectively eliminate the drawbacks in the prior art LED ceiling lights.

### SUMMARY OF THE INVENTION

A primary object of the present invention is to provide a pattern/character displaying LED lamp structure with invisible T-bar support, which is mounted to a ceiling via T-bars for displaying patterns or characters on lamp panels of the LED lamp structure while all the T-bars are invisibly located behind the lamp panels, so that the patterns or characters displayed on the lamp panels are complete without leaving undesired blanks at joints of any two adjoining lamp panels. Thus, the LED lamp structure can be used not only as lighting fixture, but also as a special lighting device to display large-sized patterns or characters showing, for example, a company logo.

To achieve the above and other objects, the pattern/character displaying LED lamp structure with invisible T-bar support provided according to the present invention includes a plurality of T-bars assembled to define a plurality of framed spaced; a plurality of stepped lamp panels; and a plurality of LED lamps. The stepped lamp panels respectively have a size-reduced upper half and a size-expanded lower half. When the upper halves are upward set in the framed spaces, the lower halves of adjoining lamp panels are in contact with one another to cover the T-bars, making the T-bars invisibly located behind the lamp panels. A bottom wall of each of the lamp panels is provided with lamp holes for forming characters or patterns. The LED lamps are separately set in the lamp holes with light-emitting sections thereof downward projected beyond the lamp panels, and can be lightened to display the characters or patterns on the bottom walls of the lamp panels.

According to an embodiment of the present invention, the upper half of each of the stepped lamp panels is provided on sidewalls thereof with a plurality of stop tabs downward and outward slanted from the sidewalls; and the stop tabs are provided on the sidewalls of the upper halves of the lamp panels by cutting a plurality of substantially U-shaped slots on the sidewalls. Thus, when the upper halves of the lamp panels have been separately upward set in the framed spaces defined between the T-bars, the stop tabs are hooked to an upper side of the T-bars to locate the lamp panels in place.

According to another embodiment of the present invention, the upper half of each of the stepped lamp panels is provided on sidewalls thereof with a plurality of stop tabs upward and outward slanted from the sidewalls; and the stop tabs are provided on the sidewalls of the upper halves of the lamp panels by cutting a plurality of substantially n-shaped slots on the sidewalls. Thus, when the upper halves of the lamp panels have been separately upward set in the framed spaces defined between the T-bars, the stop tabs are hooked to an upper side of the T-bars to locate the lamp panels in place.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows a conventional T-bar supported LED ceiling light;

FIG. 2 is an exploded perspective view of a pattern/character displaying LED lamp structure with invisible T-bar support according to a preferred embodiment of the present invention;

FIG. 3 is a fragmentary side view showing two adjoining lamp panels for the pattern/character displaying LED lamp structure according to the present invention;

FIG. 4 is a fragmentary side view showing a first embodiment of the lamp panel for the pattern/character displaying LED lamp structure according to the present invention;

FIG. 5 is a fragmentary side view showing a second embodiment of the lamp panel for the pattern/character displaying LED lamp structure according to the present invention;

FIG. 6 shows the mounting of an LED lamp to the lamp panel according to the present invention;

FIG. 7 shows an example of displaying characters on one single lamp panel of the LED lamp structure according to the present invention; and

FIG. 8 shows an example of displaying a pattern on six adjoining lamp panels of the LED lamp structure according to the present invention.

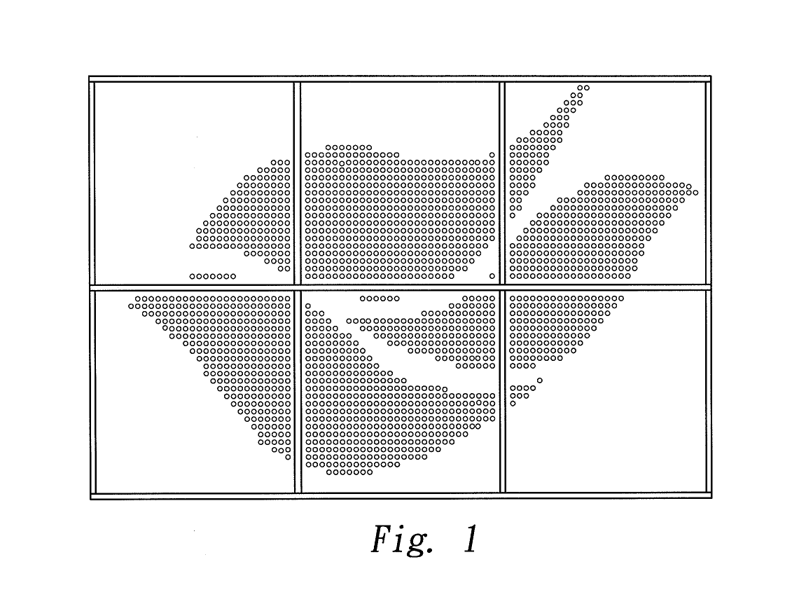

### DETAILED DESCRIPTION OF THE PREFERRED EMBODIMENTS

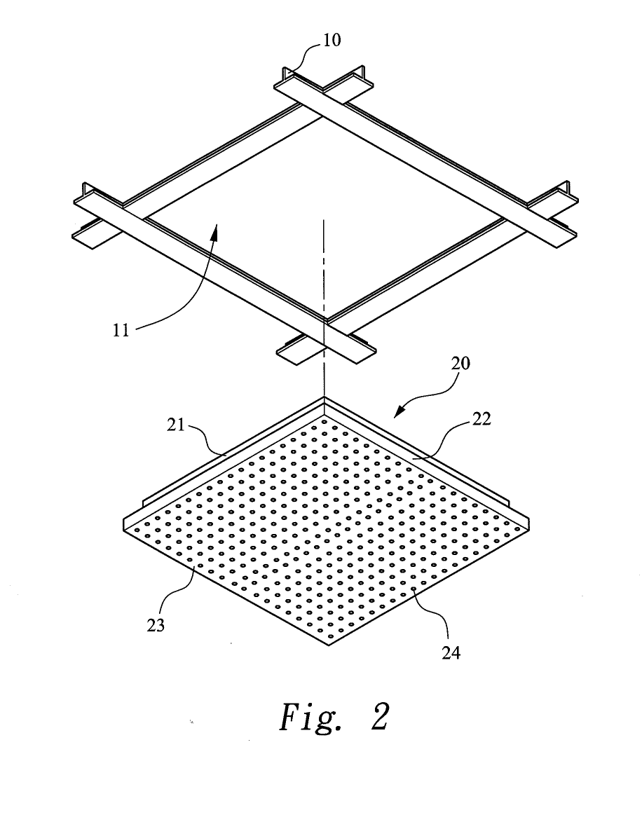

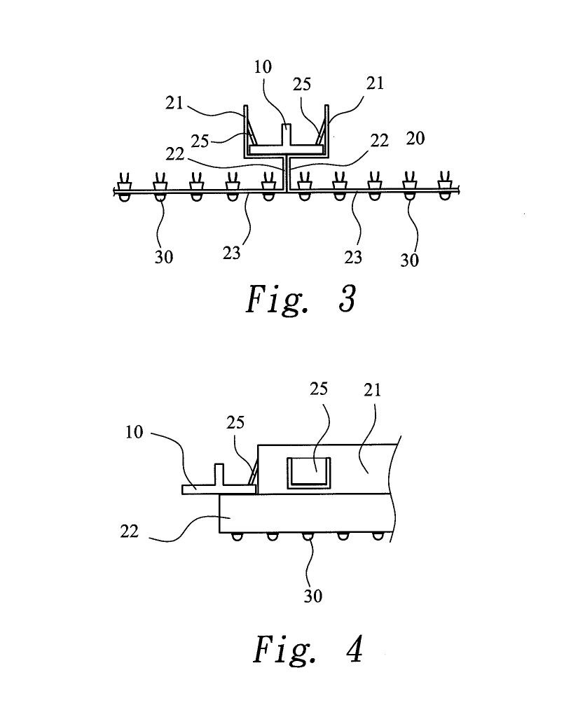

Please refer to FIG. 2 that is an exploded perspective view of a pattern/character displaying LED lamp structure with invisible T-bar support according to a preferred embodiment of the present invention, and to FIG. 3 that is a fragmentary side view showing two adjoining lamp panels for the LED lamp structure of the present invention.

As shown, the pattern/character displaying LED lamp structure with invisible T-bar support according to a preferred embodiment of the present invention includes a plurality of T-bars 10 for assembling to a ceiling to form a plurality of framed spaces 11, and a plurality of lamp panels 20 for separately setting in the framed spaces 11. Each of the lamp panels 20 has stepped sidewalls to thereby form a size-reduced upper half 21 and a size-expanded lower half 22. The size-reduced upper half 21 of the lamp panel 20 can be upward set in one framed space 11 from a lower side of the T-bars 10, such that the size-expanded lower halves 22 of any two adjoining lamp panels 20 are in contact with each other to thereby completely cover the T-bar 10 located therebetween, making all the T-bars 10 invisibly located behind the lamp panels 20. Each of the lamp panels 20 has a bottom wall 23, on which a plurality of lamp holes 24 is provided to show one or more characters or patterns on the lamp panel 20.

FIG. 4 is a fragmentary side view showing a first embodiment of the lamp panel 20. As shown, a plurality of stop tabs 25 is formed on the sidewalls of the size-reduced upper half 21 of the lamp panel 20. The stop tabs 25 are downward and outward slanted from the sidewalls of the upper half 21. When the upper half 21 of the lamp panel 20 has been upward set in the framed space 11 from the lower side of the T-bars 10, the outward slanted stop tabs 25 would hook to an upper side of the T-bars 10.

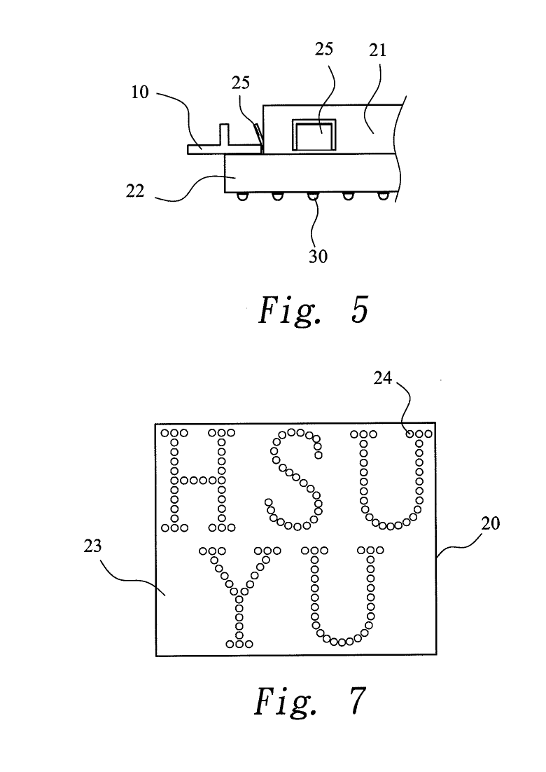

FIG. 5 is a fragmentary side view showing a second embodiment of the lamp panel 20. As shown, the stop tabs 25 formed on the sidewalls of the size-reduced upper half 21 of the second embodiment of the lamp panel 20 are upward and outward slanted from the sidewalls of the upper half 21. When the upper half 21 of the lamp panel 20 has been upward set in the framed space 11 from the lower side of the T-bars 10, the outward slanted stop tabs 25 would hook to an upper side of the T-bars 10.

Preferably, as in the first embodiment of the lamp panel 20 shown in FIG. 4, the stop tabs 25 are formed on the upper half 21 by cutting a plurality of substantially U-shaped slots on the sidewalls of the upper half 21; or as in the second embodiment of the lamp panel 20 shown in FIG. 5, the stop tabs 25 are formed on the upper half 21 by cutting a plurality of substantially n-shaped slots on the sidewalls of the upper half 21. Alternatively, the stop tabs 25 can be externally welded, screwed, or riveted to the sidewalls of the upper half 21 of the lamp panel 20.

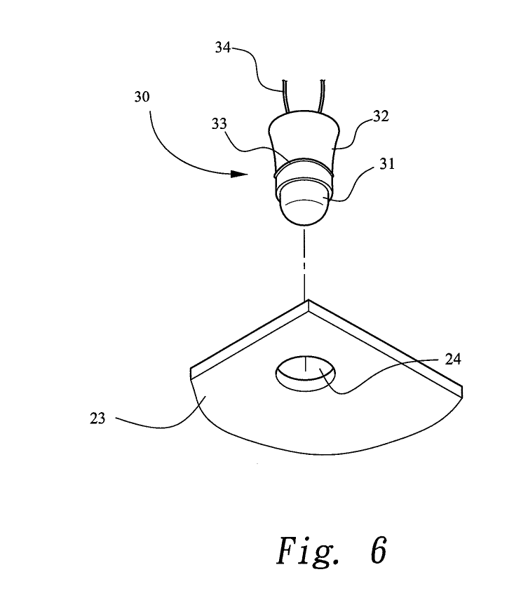

FIG. 6 shows the mounting of an LED lamp 30 to the lamp panel 20. The pattern/character displaying LED lamp structure with invisible T-bar support according to a preferred embodiment of the present invention further includes a plurality of LED lamps 30. The LED lamps 30 are separately downward set in the lamp holes 24 on the bottom walls 23 of the lamp panels 20 from an upper side thereof. Each of the LED lamps 30 includes an LED 31 and a protective base 32 enclosing part of the LED 31. A locating section 33 is externally provided on the protective base 32 for abutting against the upper side of the bottom wall 23, so that the LED lamp 30 can be fixed to the lamp hole 24 on the lamp panel 20. A light-emitting section of the LED 31 of the LED lamp 30 is downward projected beyond the bottom wall 23 of the lamp panel 20 with two connecting pins of the LED lamp 30 located inside the lamp panel 20. The LED lamps 30 are connected to one another in serial or in parallel via electric wires 34 connecting to the pins, so that all the LED lamps 30 can be lightened.

FIG. 7 shows an example of displaying some characters on one single lamp panel of the LED lamp structure according to the present invention. As shown, lamp holes 24 can be formed on the bottom wall 23 of the lamp panel 20 corresponding to characters H, S, U, Y and U; and then, an LED lamp is set in each of the lamp holes 24. When the LED lamps are lightened, two groups of characters showing “HSU” and “YU” are displayed.

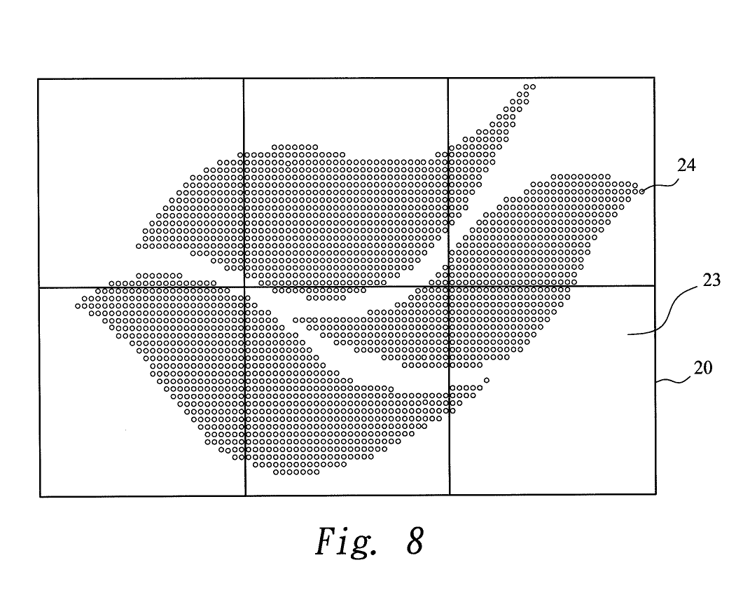

A group of characters or a large pattern can also be displayed on several lamp panels 20 at the same time. FIG. 8 shows an example of displaying a pattern on six adjoining lamp panels of the LED lamp structure according to the present invention. To do so, the bottom walls 23 of the six lamp panels 20 are provided with a plurality of lamp holes 24 corresponding to the pattern to be displayed. Each of the lamp holes 24 has one LED lamp fixed thereto. When all the LED lamps are lightened, a complete pattern is displayed on the six lamp panels 20 without leaving undesired blanks between any two adjoining lamp panels 20.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A pattern/character displaying LED lamp structure with invisible T-bar support, comprising:
a plurality of T-bars being assembled to define a plurality of framed spaces;
a plurality of lamp panels, each of the lamp panels having stepped sidewalls to thereby form a size-reduced upper half and a size-expanded lower half; each of the size-reduced upper halves of the lamp panels being upward set in one of the framed spaces from a lower side of the T-bars, such that the size-expanded lower halves of any two adjoining lamp panels are in contact with each other to thereby completely cover the T-bar located therebetween; and a plurality of lamp holes being provided on a bottom wall of each of the lamp panels for together forming desired characters or patterns to be displayed on the lamp panels; and
a plurality of LED lamps being separately downward set in the lamp holes from an upper side of the lamp panels, each of the LED lamps having a light-emitting section downward projected beyond the bottom walls of the lamp panels, and two pins located inside the lamp panels; whereby when all the LED lamps are lightened, the characters or patterns corresponding to the lamp holes are displayed.

2. The LED lamp structure as claimed in claim 1, wherein the upper half of each of the stepped lamp panels is provided on sidewalls thereof with a plurality of stop tabs downward and outward slanted from the sidewalls; whereby when the upper halves of the lamp panels have been separately upward set in the framed spaces defined between the T-bars, the stop tabs are hooked to an upper side of the T-bars.

3. The LED lamp structure as claimed in claim 2, wherein the stop tabs are provided on the sidewalls of the upper halves of the lamp panels by cutting a plurality of substantially U-shaped slots on the sidewalls.

4. The LED lamp structure as claimed in claim 1, wherein the upper half of each of the stepped lamp panels is provided on sidewalls thereof with a plurality of stop tabs upward and outward slanted from the sidewalls; whereby when the upper halves of the lamp panels have been separately upward set in the framed spaces defined between the T-bars, the stop tabs are hooked to an upper side of the T-bars.

5. The LED lamp structure as claimed in claim 4, wherein the stop tabs are provided on the sidewalls of the upper halves of the lamp panels by cutting a plurality of substantially n-shaped slots on the sidewalls.

6. The LED lamp structure as claimed in claim 1, wherein the LED lamps together display a group of characters or a pattern on the bottom wall of any single one of the stepped lamp panels.

7. The LED lamp structure as claimed in claim 1, wherein the LED lamps together display a group of characters or a pattern on the bottom walls of two or more adjoining ones of the stepped lamp panels.

8. The LED lamp structure as claimed in claim 1, wherein the LED lamps are connected to one another in serial or in parallel via electric wires connecting to the pins of the LED lamps.

9. The LED lamp structure as claimed in claim 1, wherein each of the LED lamps includes an LED and a protective base enclosing part of the LED, and the LED lamps are set in the lamp holes on the stepped lamp panels with the protective bases fitted in the lamp holes.
